(19) United States
(12) Patent Application Publication
(10) Pub. No.: US 2025/0046000 A1
(43) Pub. Date: Feb. 6, 2025

(54) ADVANCED MULTIMEDIA SYSTEM FOR ANALYSIS AND ACCURATE EMULATION OF LIVE EVENTS

(71) Applicant: Shai HAREL, Kfar Yona (IL)

(72) Inventor: Shai HAREL, Kfar Yona (IL)

(21) Appl. No.: 18/717,274

(22) PCT Filed: Dec. 18, 2022
(86) PCT No.: PCT/IL2022/051344

§ 371 Date: Jun. 6, 2024

(30) Foreign Application Priority Data
Dec. 20, 2021 (IL) 289178

(51) Int. Cl. G06T 15/00; G02B 30/00; G03B 21/14; G06T 19/00; H04N 21/81

(52) U.S. Cl. CPC G06T 15/005; G02B 30/00; G03B 21/14; G06T 19/00; H04N 21/816

(57) ABSTRACT

A system for emulating a remote live event or a recorded event at a client side, while optimally preserving the original experience of the live or recorded event, comprising a remote side located at the live event 3D spatial environment and being adapted to collect and to analyze spatial environment with multi-channels data from an array of sensors deployed at remote side. The remote side comprises a publisher device for, (a) collecting multi-channels data, (b) generating dynamic spatial 4D map, (c) synchronizing and editing the data of the live event to comply with the displayed scenario, and (d) generating an output stream ready for high bandwidth distribution with correlated adaptation to client. The system further comprises a client side located at the facility of a user with an integrated input/output device platform, comprises multimedia and sensory components, such visual devices 2-D, 3-D, 7-D projectors, an audio devices, a light fixture devices.

### FIELD OF THE INVENTION

The present invention relates to the field of multimedia systems. More particularly, the present invention relates to systems emulating live or pre-recorded remote events at a client side of a user, while optimally preserving the original experience of the event, like the user would have been a participating user.

### BACKGROUND OF THE INVENTION

Live events such as musical performances are widespread all over the world. Such live events are recorded and then transmitted to millions of users all over the world. Alternatively, such live events are edited and streamed in real-time to remote audience as multimedia content.

Transmission and streaming of advanced multi-channels of a happening event at a single or at multiple locations generate a composite multimedia content. Such multimedia content requires available gigabyte data rates and high bandwidth network infrastructure, which are spreading rapidly in the world. Such infrastructure may be in the form of fiber-optics, fast cables lines at homes, offices and business places for providing fast internet networking, so as to serve the growing number of connected devices such as computers, multimedia/media center devices, mobile devices, hardware devices smart machines, consoles utilities and the like. Even remote sites that are far from the internet core lines are getting fast internet services from satellites.

Other fast infrastructure is the 5G cellular cells and gigabyte bandwidth network transceivers, which enable the mobility of such devices while connecting to broad band networks. The TERA-BYTE networks are right at the corner in a shape of 10G (XG) generation ultra-wideband and higher data rates.

Live events provide an amazing experience to audience who are present in the 3D spatial environment, in which these events happen. The experience captured by the bio-senses of the audience includes multi-direction audio and 3-D visual effects which build a unique experience to each participating user. The experience is subject not only to the transmitted audio and lighting effects, but also to the location of each person from the audience with respect to loudspeakers, projectors and other instruments, as well as to other persons and the distal or proximal 3D spatial environments, surrounding each person.

Existing multimedia systems collect and edit the audio-visual data, before transmitting or streaming it to remote users. However, these conventional systems are limited in their ability to emulate the same experience as in participating in the live event, since at most, the visual effects are limited to the transmission of a single edited channel carrying 2-D video streams from the event, which are displayed on a single display screen (such as a TV screen) or on any wearable on-eyes display devices. Such 2-D transmissions (of a single channel) are not capable of emulating a real live event, with all the audio-visual effects and sensory feelings that take place in a live event.

It is therefore an object of the present invention to provide a system and method for emulating a remote live event at a client location, while optimally preserving the original experience of the live event.

It is another object of the present invention to provide a system and method for emulating a remote live event at a client location, without requiring the users to use wearable devices.

Other objects and advantages of the invention will become apparent as the description proceeds.

### SUMMARY OF THE INVENTION

A system for emulating a remote live event or a recorded event at a client side, while optimally preserving the original experience of the live or recorded event, comprising a remote side that is located at the live event 3D spatial environment and being adapted to collect and analyze multi-channels data from an array of sensors deployed at the remote side. The remote side comprises a publisher device for collecting data from all sensors' multi-channels at the live event; decoding the channels data to an editable format; generating dynamic spatial location and time map layers describing dynamic movements during the live or recorded event; synchronizing the live event using time, 3D geometric location and media content; editing the data of the live event to comply with the displayed scenario and to optimally fit the user's personal space geometric structure; generating an output stream that is ready for distribution with adaptation to each client. The system also comprises a client side located at the facility of a user, which comprises a multimedia output device for generating for each client, multi-channel signals for executing an emulated local 3-D space with Personal/Public Space Enhancement (PSE) that mimics the live event with high accuracy and adaptation to the facility; at least one server for processing live streamed wideband data received from the remote side and distributing edited content to each client at the client side.

The audio-visual sensory projection and processing device may be adapted to:
a) decode the edited output streams received from the publisher device into multiple data layers running at the client side;
b) synchronize the data and control commands;
c) process the visual and audio signals, lighting signals and signals from sensors;
d) rebuild the scenarios belonging to the live event and make them ready for execution;
e) rout the outputs to each designated device to perform a required task; and
f) distribute outputs that refer to each client. The output can be a visual output in all light frequencies, audio waves in all audio frequencies and sensors reflecting sense.

The emulated volume local space may be executed by a multimedia output device, which receives the signals generated by an audio-visual-sensors, emulation, projection and processing device for a specific client and executes the signals to generate the emulated local space and PSE for the specific client.

The multimedia output device may comprise one or more of the following:
a) a video device;
b) a visual device;
c) an audio device;
d) a light fixture device;
e) one or more sensors;
f) power and communication components;
g) smoke generators;
h) fog generators;
i) robotic arms;
j) hovering devices;
k) machine code devices;
l) Internet of Things (IoT) devices.

The light fixture device may be a 2-D or 3-D projector having at least pan, tilt, zoom, focus and keystone functions and may be a PTZKF projector.

The 3-D projector may be a 7-D sphere projector that projects a real complete sphere video and visual output to cover a geometric space from a single source point of projection.

The publisher device may use mathematical and physical values of a dynamic grid along with media channels telemetric data indicators and media content visual and audio.

The array of sensors may be a sensor ball, which is an integrated standalone unit and is adapted to record, analyze and process an event in all aspects of video, visual, audio and sensory data.

Data processing at the client and remote sides may be done using software and hardware being digital and/or analog processing.

Artificial Intelligence and machine learning algorithms may be used for making optimal adaptations to each client side and remote side.

Data in the remote and/or client sides may be generated and delivered using communication protocols being to utilize high bandwidth for advanced functionality.

The system may be adapted to perform at least the following operations:
process, merge and multiplex the data;
synchronize the data between publishers, servers and a plurality of client sides;
perform live streaming of multimedia data on broad high bandwidth networks;
make adaption to lower bandwidth.

The events may be live or recorded events, virtual generated events or played-back events from a local or network source.

The audio-visual projection and processing device further may comprise a plurality of sensors for exploring the 3D spatial environment of each local user and making optimal adaptation of the editing to the 3D spatial environmental volume.

The multimedia output device may be used as a publisher, to thereby create an event of a local user to be emulated at the 3D space of other users or at the remote event.

The multimedia output device may comprise:
a) an optical source for generating modulated circular waves at predetermined frequencies;
b) two or more orthogonally positioned screw shapes tubes, for conveying the modulated circular waves to a conical prism;
c) a conical prism for generating an output of complete spatial grid with high resolution geometrical shape; and
d) a disk prism spinning at a predetermined rate, for producing transmitted optical waves that cause interference in desired points along the grid, while at each point, generating spatial pixels with colors and intensity that correspond to the image to be projected.

The spatial grid may be spherical or conical or any predefined geometric shape.

The output stream may be in a container format, being dedicated for multi-channels.

The audio-visual sensory projection and processing device may be configured to:
a) sample the user local audio output at the user's local side;
b) and performing real-time adaptive synchronization, based on the data extracted from the local audio output, to optimally match the user's local side to the streamed source data.

The system may be adapted to perform audio to video synchronization, audio to light synchronization and video to light synchronization.

The 7D large-scale outdoor projector may be implemented using a gun of particles that transmits energy waves and/or particles in predetermined frequencies and using several modulation schemes, to generate 3D spatial pixels at any desired point along the generated spatial 3D grid, to thereby create a desired view in the surrounding volume.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a general block diagram of the system in accordance to some embodiments of the present invention;

FIG. 2 illustrates a 4D correlated and dynamic mapping of a remote live event, according to some embodiments of the present invention;

FIG. 3A illustrates the synchronization between input channels performed during or after the live event, according to some embodiments of the present invention;

FIG. 3B illustrates a 3-Dimensional chart of time including past, present and future, according to some embodiments of the present invention;

FIG. 4 illustrates the implementation of a sensor ball, according to some embodiments of the present invention;

FIGS. 5A and 5B illustrate the implementation of the integrated output devices, according to some embodiments of the present invention;

FIG. 6 illustrates an implementation of the integrated output device with a ceiling overhead mounting, according to some embodiments of the present invention;

FIG. 7 illustrates an implementation of a PTZFK video projector, according to some embodiments of the present invention;

FIG. 8 illustrates an implementation of a Wondermoon 360° projector, according to some embodiments of the present invention.

FIG. 9 illustrates an implementation of a 7D projector, according to some embodiments of the present invention;

FIG. 10 illustrates the generation of the projected images by the 7D projector, according to some embodiments of the present invention; and

FIG. 11 illustrates an implementation of a large scale outdoor 7D projector, according to some embodiments of the present invention.

### DETAILED DESCRIPTION OF THE PRESENT INVENTION

The present invention is of a system for emulating a remote live event at a client side, while optimally preserving the original experience of live, recorded or streamed events.

In accordance with some embodiments of the present invention the system uses communication protocols adapted to the growing bandwidth and utilizes the growing bandwidth for more advanced functionality.

The system of the present invention uses multi-channels during all steps of the process, starting from collecting the data from the sensors deployed at the site of the remote live event, continuing with processing steps at the publisher's side (encoding, mapping, synchronizing, editing, generating an output stream) until receiving and processing the streamed data (decoding, routing, distributing an output stream), in order to accurately emulate the live event by a hardware device at each client side, with adaptation to his Personal/Public Space Enhancement (PSE) capability, as will be described later on. The continuous use of multi channels allows accurately reproducing of the remote event to any local user on the client side.

By using the term “sensors”, it is meant to also include a machine executable code (converted to operational signal) that is collected from any device deployed in the live/recorded event, such as a lighting device.

The personal space of the user is defined as the 3D spatial environment, confined by the physical volume space surrounding the user (in contrast to conventional 2-D screen or 3-D simulation presented on single or dual 2D eyewear display).

In accordance with some embodiments of the present invention, the system performs data collection and analysis in the 3D spatial environment of the live event at the remote side and emulation of the live event in the 3D spatial environment of the local user at the client side, in which the live event will be presented. This allows enhancing the performance and experience of movies, television programs, electronic games and realty shows, using multiple displays, multi-light effects, multi-sound effects, as well as multi-sensing.

Also, data collected from the live event and from the emulated event may be collected and analyzed in order to find the level of correlation between them. In one aspect, the emulated event is happening simultaneously at several user's locations and all of them are feeling the same experience of the same live event.

According to an embodiment of the invention, each local user may also be a publisher that shares an event with other users.

The system architecture comprises a remote side (located at the live event) and a client side (located at the user's place) with different layers to be able to handle all multidisciplinary system requirement for collecting vast amount of sources of data channels, such as audio, video, light fixture, sensors and other entities. The system is adapted to process, merge and multiplex the data and to synchronize the data between publishers, servers and a plurality of client sides. The system is capable of performing live streaming of multimedia the data on broad high bandwidth networks, or to make adaption to lower bandwidth.

In accordance with some embodiments of the present invention, processing is done by a broadband server architecture with high bandwidth data handling and distribution capabilities with server control tasks and management.

At the user side, a client application manages high volume of data stream reception, advanced container format, data decoding, local synchronization and outputting and routing the data to mimic the live (source) event, visual shown effects, audio and sound content, other occurring according to the remote source applications.

Data processing at the client side may be done using software and hardware and may be digital/analog and may involve Artificial Intelligence (AI) and machine learning techniques, as well as bio-sensing.

To generate advance communication protocols, the system utilizing advanced formats and advances containers format and advanced codec's, control layers, cyber security layers that contain high bandwidth synchronized multi channels of multimedia, machine code in one united stream or several divided streams.

The system handles ultra-high bandwidth data from real video 4D/7D sources to real 4D/7D display method in order to obtain a Personal Space Enhancement or Public Space Enhancement.

In accordance with some embodiments of the present invention, the system allows streaming of live or recorded events, playback or virtual generated events (such as large stadium rock concert show with vast multimedia utility coverage, cameras in various location and angels, large amount of microphones, devices for capturing singers and instrumental players, audience voice, mummers, lights fixtures some also with rotated axis, and other devices like laser show, smoke device, star shape projector etc.). Live events may be, for example:
worldwide live concert shows, such as musical concerts, theater shows;
worldwide live club, such as disco club, DJ events, virtual disco club;
worldwide live cinema, such as movies and shows;
worldwide live console games such, PSE emulated games, network multiuser games, local multi-user interactive games, AI content emulated games;
worldwide live clouds;
worldwide live Virtual Reality (VR), Augmented Reality (AR), Mixed Reality (MR-merging of real and virtual worlds to produce new environments and visualizations, where physical and digital objects co-exist and interact in real time);
worldwide live connections such as, virtual meetings, group meetings, social meet-ups;
worldwide live community;
worldwide live collaborations;
worldwide live congresses hall;
worldwide live control center.

In accordance with some embodiments of the present invention, events may be played-back from a local or network source such as V.O.D and the like.

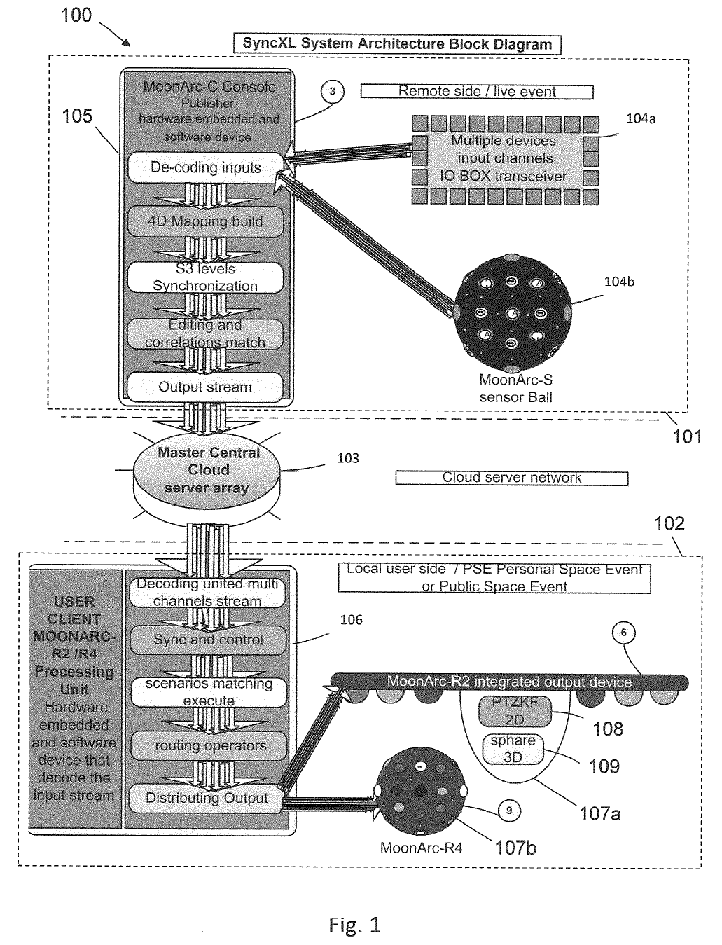

FIG. 1 is a block diagram of the system in accordance with some embodiments of the present invention. The system 100 comprises a remote side 101 located at the live event area and a client side 102 which is the facility of a user (for example, home or office). The remote side 101 communicates with a plurality of clients (users) via a data network. An array of servers 103 processes the live streaming wideband data on broad high bandwidth networks and distributes edited content to each client. The array of servers may be connected to additional servers, for providing services like gaming, movies, music, social networking, community networking (social networking for defined communities), business networking (business meetings, trade shows, conventions, cross-state and global meetings), etc. The remote side 101 is responsible for collecting multi-channels data from an array of sensors at the remote side in which a live event takes place. The array of sensors may be an IO Box 104a with multiple devices channels input/output transceiver which includes hardware and software to collect all existing data channels and media channels of thirdparty equipment deployed in the event. Alternatively, the array of sensors may be a sensor ball 104b, which is an integrated standalone unit. Several IO Boxes 104a and sensor balls 104b may be used for recording the event as a synchronized network of sensors balls 104b, or as a single unit. Each sensor ball 104b may be a hardware and or software device which is adapted to record, analyze, and process an event in all aspects of video, visual, audio and sensory data. The array of sensors may include multiple sensors of telemetric data of various kinds, such as ambient light measurements, differential sound noise levels measurements, temperature measurements at several points, air pressures gauges, air moisture gauges, UV effects. The array of sensors may also include a network of bio feedback sensors, physiology feedback networks, location in GEO and local, angular velocity and acceleration angular position, sensing particles in all forms and appearing states.

The system 100 may comprise a live event publisher device 105 at the remote side 101, which is a hardware device with embedded software (or a computer/server). The publisher device 105 may collect data from all sensors' multi-channels from the live event (such as video, audio, and light effects, sensory data) and decodes the channels data to an editable format. At the next step, the publisher device 105 may generate a 4D (location, and time) map layers that describe the live event using mathematical and physical values of a dynamic grid along with media channels telemetric data indicators and media content (visual and audio, as well as sensory data). At the next step, the publisher device 105 may synchronize the live event using 3 levels of complexity: time, 3D geometric location and media content. At the next step, the publisher device 105 may edit the data of the live event to comply with the displayed scenario and to optimally fit the user's personal space geometric structure (which is different for every user. The result is an output stream that is ready for distribution to a plurality of clients.

The system may further comprise an audio-visual sensory projection and processing device 106 at each client side 102, for emulating the live event. The audio-visual projection and processing device 106 is a hardware device with embedded and high level software, for generating for each client, signals for executing an emulated local space with Personal/Public Space Enhancement (PSE) that mimics the live event with high accuracy.

Device 106 may first decode the edited output streams received from the publisher device 105 (that have been distributed by the array of servers 103) into multiple data layers running at the client side. At the next step, device 106 may synchronize the data and control commands and may process the video and audio signals, as well as lighting signals with signals from sensors. For example: a searchlight that is activated at the left of the stage follows a predefined route recorded from a machine code. The related sensory process remotely analyzes the light intensity, frequency, else value at certain positions and time at the light path, in order to generate a data set that represents. The same process may be replicated at the (local) user side: the search light movement, path with sensor feedback using machine code to operate the search bar fixture entity and a sensor integrated to actual synchronizing of time and location between the output light to the flux intensity at user 3D spatial environment.

In accordance with other embodiments of the present invention, device 106 may be configured to sample the user local voice output, for performing real-time adaptive synchronization, based on data extraction from the heard audio at the user's local side, to optimally match the user's local side to the streamed source data.

At the next step, device 106 may rebuild the scenarios belonging to the live event and may make them ready for execution. At the next step, device 106 may direct the outputs to each designated device (such as 2-D/3-D/7-D projectors, loud speakers and sensing effect) to perform a required task. At the next step, device 106 may distribute outputs that refer to each client (user).

The output can be a visual output in all light frequencies, audio waves in all audio frequencies and sensors reflecting sense. The sensors at the remote event may also affect the PSE. For example, the temperature sensor recordings at the event may cause a loop back chain of a local user temperature to keep the same temperate at the PSE by activating an air-condition device.

The emulated local 3D spatial space may be executed by a multimedia output device 107a, which receives the signals generated by device 106 for a specific client and executes them to generate the emulated local space and PSE for that specific client. In accordance with some embodiments of the present invention, multimedia output device 107a/107b is a hardware and/or software integrated platform that comprises multimedia and sensory components, including a video device, a visual device, an audio device, a light fixture device (such as projectors), sensors, as well as power and communication components. The projector may be a 2-D projector 108 or a 3-D projector 109. 2-D projector 108 may be a disk projector with pan, tilt, zoom, focus and keystone (distortion correction) functions that enable the projector to move to any pan a tilt to any given axial position, auto zoom the video projection, auto focus adjusting, auto keystone adjusting, auto laser scanning and length finder, CCD camera sensor(s), video reflection projection modulated output and audio outputs.

In accordance with some embodiments of the present invention, 3-D projector 109 may be a sphere projector that projects a real complete sphere video and visual output to cover all room or other geometric space from a single source point of projection. The output device may be a 7-D projector, which provides a real perception of the 3-D spatial environment that surrounds the local user.

In order to define the 3-D virtual midair spatial environment perspective, at least two local users should be present. Each user may have a perception of a 3-D space and may see and acknowledge the virtual volume surrounding himself and may see the other user who may also have his own 3-D space with seeing and acknowledging the virtual surrounding. This defines the volume space perspective and extracts the dimension to 6-D. The 7th dimension is time, since the 3-D spatial environment is dynamic and changes over time. The 7D is a point of perspective in order to define the virtual volume environment and not restricting a single or any entity device user, to experience the volume environment as sole person intact.

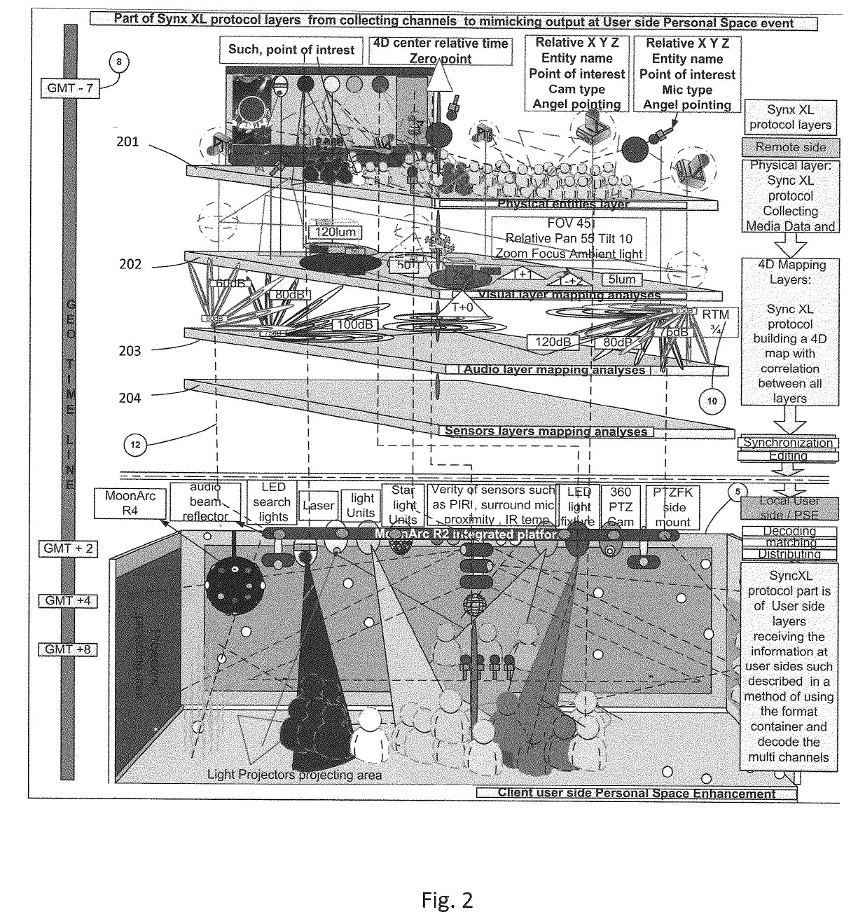

FIG. 2 illustrates a 4D correlated and dynamic mapping of a remote live event, according to an embodiment of the invention. The system generates a 4D geometric structured data of the 3D spatial environment and the associated multiple channels and movements in correlation to relative position entities that are recorded for further processing according to the system's protocol.

In accordance with some embodiments of the present invention, the structured data may comprise a physical entities layer 201 with a graphical display output of the various entities with their relative position and time in the live event, the relative static and dynamic coordinate position/velocity of all entities at the current space of the recording transmitted and samples during the live event. The physical entities may include the location of devices such as cameras (with their field of view), microphones, loudspeakers, projectors, as well as the location of each participant with respect to the reference relative point of the audience (viewer standing point and view direction).

The structured data may also comprise a visual layer 202 with graphical display output in relative position and time of any visual scene that takes place, along with the spherical angle and the Field Of View (FOV) and other optical parameters associated with surround lighting measures and frequencies and levels in the environment of the live event.

The structured data may also comprise an audio layer 203 with graphical display output in relative position and time of the taken audio sound recording directions in space, echoing phase feedback from different directions and relative levels of the audience and its surrounding.

The structured data may also comprise a sensor layer 204 with graphical display output in relative position and time of the taken input channels that contain relative bio-feedback such as air pressure, air moisture, smell, feelings, emotional states as an excitement, fears, sadness and happiness. Physiology parameters, conscientious sensors in all span of frequencies and band, particles in all form and appearing state.

In accordance with some embodiments of the present invention, pressure and moisture may be represented as a graph bar in the designated location of the sensor layers with its value as 3-D pin bed shape map, Celsius, paschal, Percentage and the like. Thermal mapping such from an IR sensor may provide a distinction of other physiological parameter as is in differential heat value and heat signature. Feeling may be detected also by verbal output and body language combined with other sensors. This may be presented as a graphical 3D matrix of 3D bed with indication on every pin node.

In accordance with some embodiments of the present invention, the 4D mapping layers graphical output may also contain:
graphical display of general relative time factor of the event entities.
entities time loops—some of the entities in the ongoing event move in space in loops like searchlight fixture in specific time loops and movement. The 4Dmapping process is programmed to recognize it and get a special indication.
geographical time factor—the 4D mapping is an integrated view of the remote and local part of the collected data for further processing, so as to acknowledge the time difference of the connected users indicated as GMT+XC or GMT−XC.
RTM (Real Time Metronome) network analyzer generator synchronizer, to adjust the synchronization of the audio and the pitch waves frame of parallel multi channels by analyzing the rhythm beat. RTM is an advanced AI synchronized feature, world first network Real-time Dynamic Metronome harmonic beat spectrum generator and analyzer.

In accordance with some embodiments of the present invention, RTM may relate each code to each beat in the metronome as a specific digital word. The RTM may analyze the audio channels in real-time or in the recorded playback and samples and may recognize repeating sound/music beats. The RTM may perform digital synchronization of audio streams by matching the RTM code of different channels to match the synchronization and echo effects between multi channels, unless needed as an effect in the restored event at the PS.
To whom it is displayed for, viewer point of stand and view and its interest in the event.
Correlation lines between remote event to local user.

The system of the present invention may be adapted to receive video inputs from multi channels (e.g., 1-500 lines and more) of shootings in all angles and perspectives of cameras which are recording the event using a rectangular or 360° field of view, in 3D, 4D, 7D, or QVCR. The video inputs may also come from video playback devices in all kind of video/streaming formats of analog and digital streaming outputs.

Video input capture displayed in quality resolutions, for instance, of HD, 4K, 8K, 32K, 1M, 1GQP and higher, for 2D, 3D, 4D, 7D QVCR video dimensions, as well as video generated by different sources such as cameras in different light frequency band sensors or on the air feed analog or digital IPTV, cables analog or other network digital video devices streaming, and particles in all form and appearing state.

The system proposed by the present invention may also be adapted to receive audio Inputs of multi channels (e.g., 1-500 lines and more) with all kinds of audio devices channels, such as microphones with omni receptions or/and directional reception in digital or analog formats, as well as audio inputs from audio playback devices in all kinds of analog and digital output/input formats of audio channels. The audio data may be related to music instruments, such as electric guitars, synthesizers and or other existing instruments, or recorded audio tracks coming from playback devices of any kind with analog or digital output formats or any digital format that run in the data network and software, in all hearable frequencies and above hearable frequencies, particles in all forms and appearing states.

The 4D mapping may be an input to the synchronization process.

The mapping process may include organizing means for organizing the collected and processed data in a structured manner, as datasets that are stored in a database. The stored data may then be used for higher level of synchronization and editing.

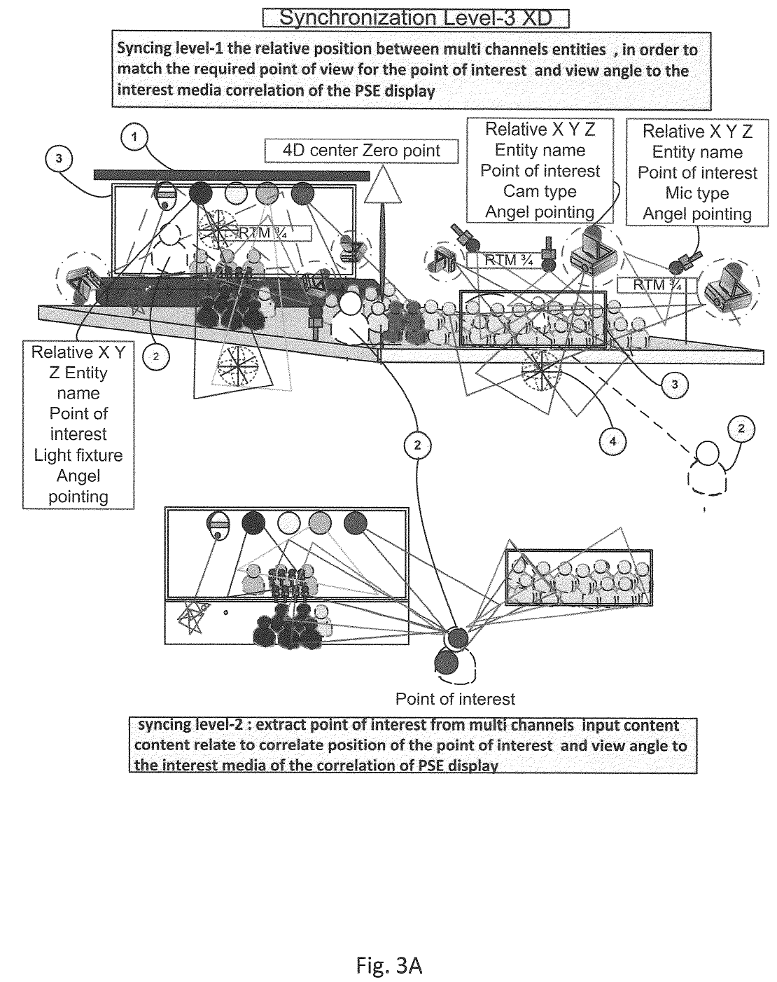

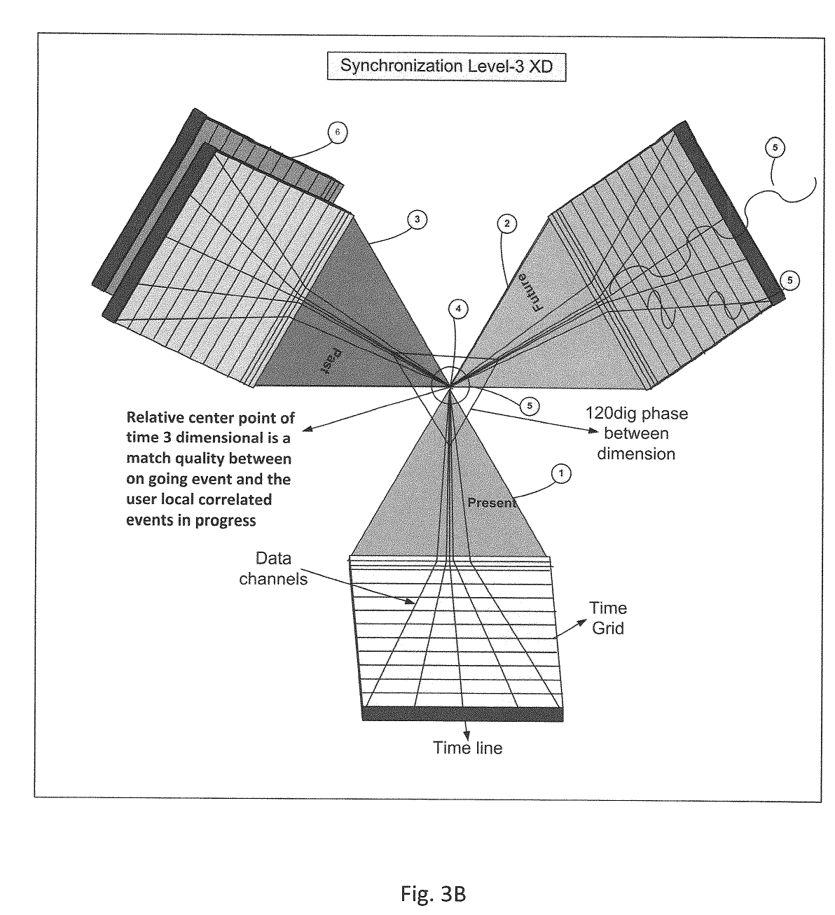

FIG. 3A illustrates the synchronization between input channels performed during or after the live event, according to some embodiments of the present invention. Accordingly, at the first stage, the relative position between the multichannel entities may be synchronized, in order to match the required point of view for the point of interest, and the view angle to the interest correlation of the PSE display.

At the second stage, the point of interest may be extracted from the multichannel input content relative to the correlation position of the point of interest and view angle are synchronized, in order to match to the interest media of the correlation of the PSE display.

The synchronization process can be set manually or semi-automatically or by automatic AI such as machine learning.

FIG. 3B illustrates a 3-Dimensional chart of time including past, present and future, according to some embodiments of the present invention. This 3-time dimension chart is simultaneously running in a phase of 120° as a triangle. The present progressive is the main dimension that all channels follow perpendicular progressive to it. All the channels in the ongoing present may be synchronized to a timeline. The future dimension is in 120° phase also running but with dynamic time changes. The calculated perception of the upcoming known scenario or predicted scenario may be processed according to current progress, in order to proceed with the synchronization further in future time and to be transmitted in advanced to users.

A control feedback may monitor the realization of the scenario and may send dynamic time gaps control commands, as required. The future synchronization dimension also considers a running device or audio or video or other feedback in continuing loops and marks a synchronization time stamp on them, where the control feedback is realizing the scenario.

An occurring past dimensional occurring event continuously checks the level of realization regarding current ongoing event and relevant to a previous event. The quality of the ongoing event is marked, as well as the correlation between 3.-dimensional time sync synchronization. A relative center point of the 3-dimensional time is a match quality between ongoing event and the user local events in progress.

In accordance with some embodiments of the present invention, the system may also be adapted to perform audio to video synchronization, audio to light synchronization and video to machine code/light synchronization, sensors to video synchronization, sensors to audio synchronization, sensors to machine code/light synchronization.

The synchronization process can be set manually or semi-automatically or by automatic such AI such as machine learning.

### Editing Stage

the collected multi channels input may be edited using the 4D dynamic mapping via multi channels synchronization. The multi channels data may be edited for the purpose of scenario adaption and may organize the scenario for a few typical use of user client-side's PSE as a typical frame building space, in order to allow high quality and resolution match restoration using a dedicated device, such as multimedia output device 107a/107b, so as to restore an event back to live at the user's location at high quality and match for maximum experience and enjoyment from the user's perspective view. During the editing process, control directive sequence control data file may be added as a part of the overall coding process. The user space volume frame build may be matched with proportion to the event space volume, so as to match the point of interest to the designated scenarios, to set the input data according to a given set of rules, and to match the perspective view by mimicking the set of locations positions, angles, device usage, visual aspects, audio aspects and other uses. Editing the input channels may be done with respect to the channels frame, including telemetry editing or content editing. The Editing process can be set manually or semi-automatically or by automatic AI such as machine learning.

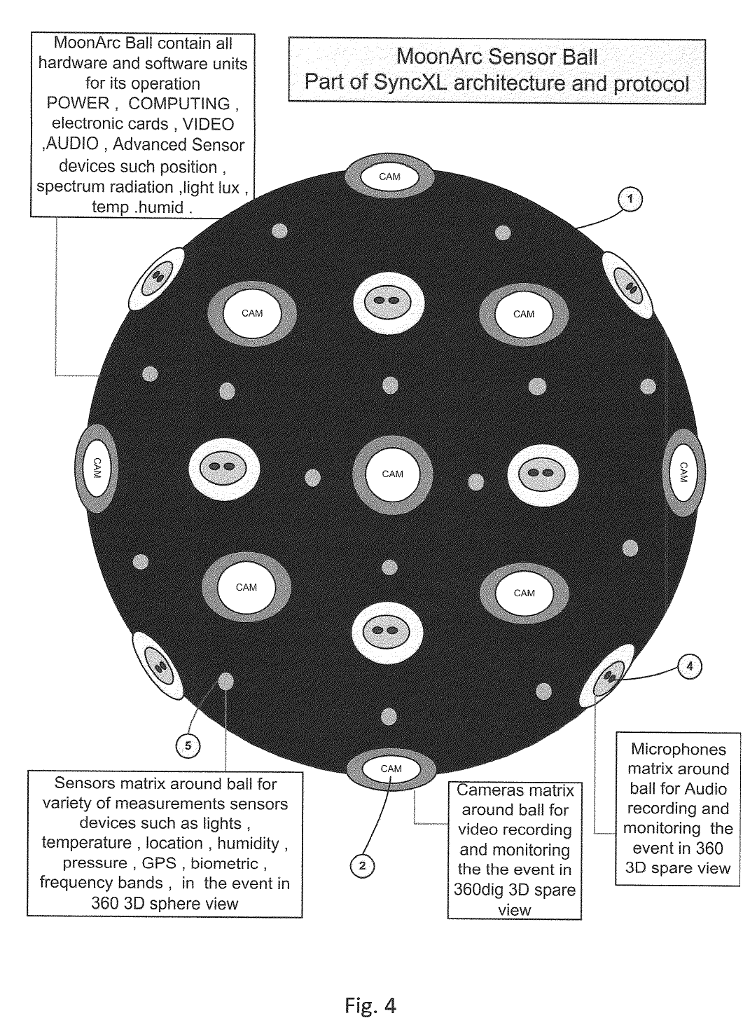

FIG. 4 illustrates the implementation of a sensor ball 104b, according to some embodiments of the present invention. The Sensor Ball 104b may contain all the utility of video devices, audio devices and sensors devices and may be capable of collecting and recording all occurrences in the event, without requiring a third party to receive partial or complete data collecting input. Several sensor Balls may be used.

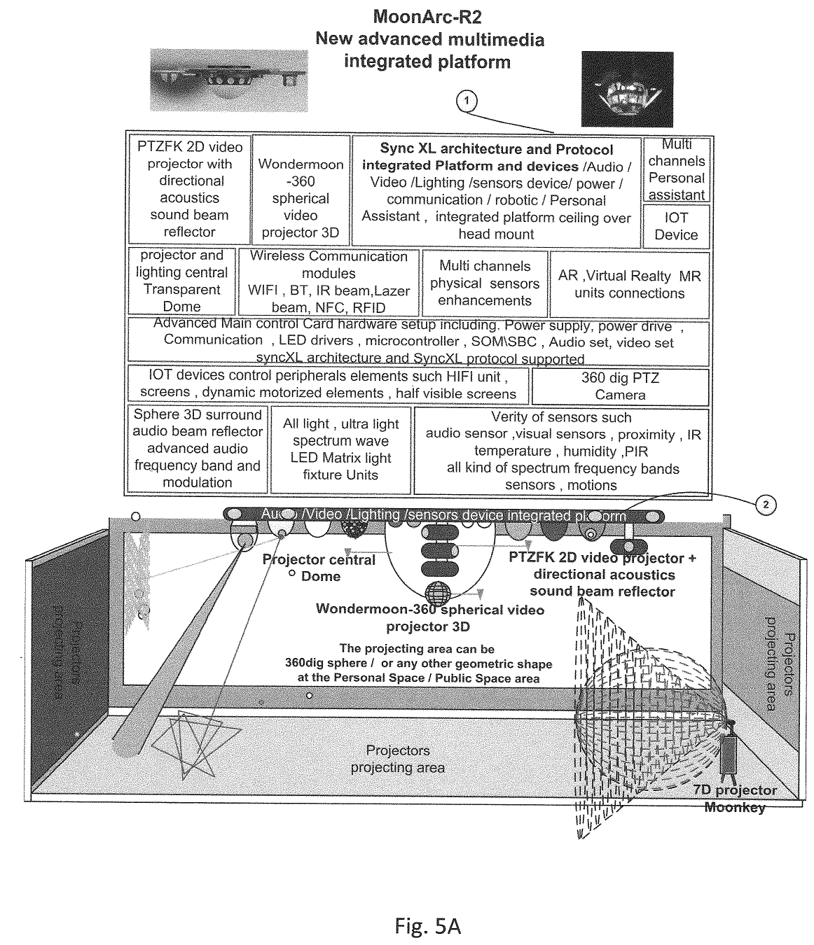

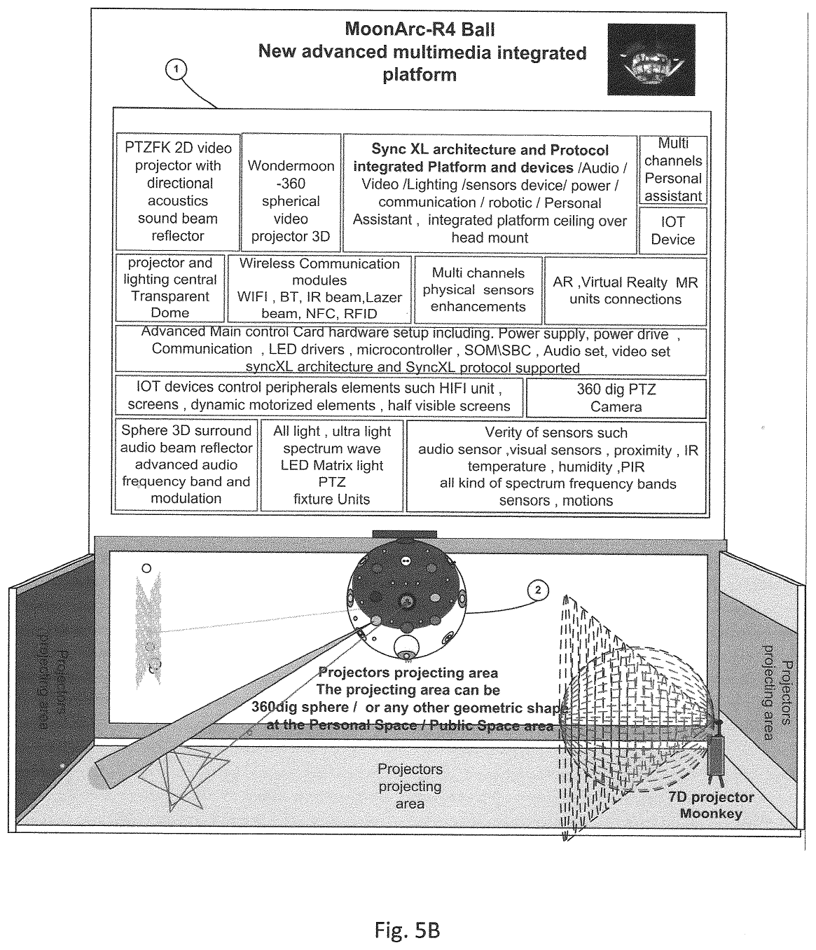

FIGS. 5A and 5B illustrate the implementation of the integrated output and input devices 107a and 107b, respectively, according to some embodiments of the present invention. The output device may be a multimedia sensory dynamic platform, combined with video devices, audio devices, light fixture devices, and sensors devices. Integrated output device 107a may enable:
multiply media presentation of multi video display numbers at the same time in the PSE Multi audio sounds outputs at the same time in the PSE;
Multi lights fixtures projection presentation at the same time in the PSE;
Multi sensor presentation as correlated activated device to output the sensor input.

In accordance with some embodiments of the present invention, video presentation and projection may be performed using projectors with controllable automatic rotated axis of Pan, Tilt, Zoom, Focus, Keystone (PTZFK), 360° sphere 3D projector of about 64K resolution (less or higher), and many advanced projectors of various kinds. This includes at least one of light fixtures in different light wave spectrum and frequency, static light forms and dynamic PTZ movements, moving lights head, laser shows, strobe shaped projecting, strobe light and smoke devices.

In accordance with some embodiments of the present invention, audio effects generation may include at least one of the following: various kind of audio devices input output of a various wave spectrum and length and power, different array of audio surround multiple outputs and stereo, so as to adapt as Omni sphere surround speakers, sound reflectors, sound beams and 7D and QACS correlated sound.

In accordance with some embodiments of the present invention, integrated output devices 107a and 107b may use at least one of the following sensors: IR and PIR temperature and camera sensors, as well as light sensors, temperature sensors, spatial location sensors, humidity sensors, pressure sensors, GPS, biometric sensors, frequency bands, sensors analyzer, geo time factor position sensors, local position sensors, velocity sensors, acceleration sensors and bio sensors.

In accordance with some embodiments of the present invention, Integrated output devices 107a and 107b may use communication integration, such as other IoT devices and other peripheral devices.

Integrated output devices 107a and 107b may be used as a publisher, to produce its own created event with all its abilities of inputs, outputs and communication.

In accordance with some embodiments of the present invention, part of the work that is done by the publisher and the local unit may be accomplishing the delta of the match correlation between remote source and the client user such as mapping, editing, synchronization process. The process can be set manually or semi-automatically or by automatic AI such as machine learning.

In accordance with some embodiments of the present invention, integrated output devices 107a and 107b may also include applicative capabilities of the local user device, such as:
Games
Sports
Health
Education
Personal assistant
Daily basis enhancement lifestyle, inspiration, mentoring
Control system
Security
Science fiction (sci-fi)
Traveling
Consciousness
Music
Movies

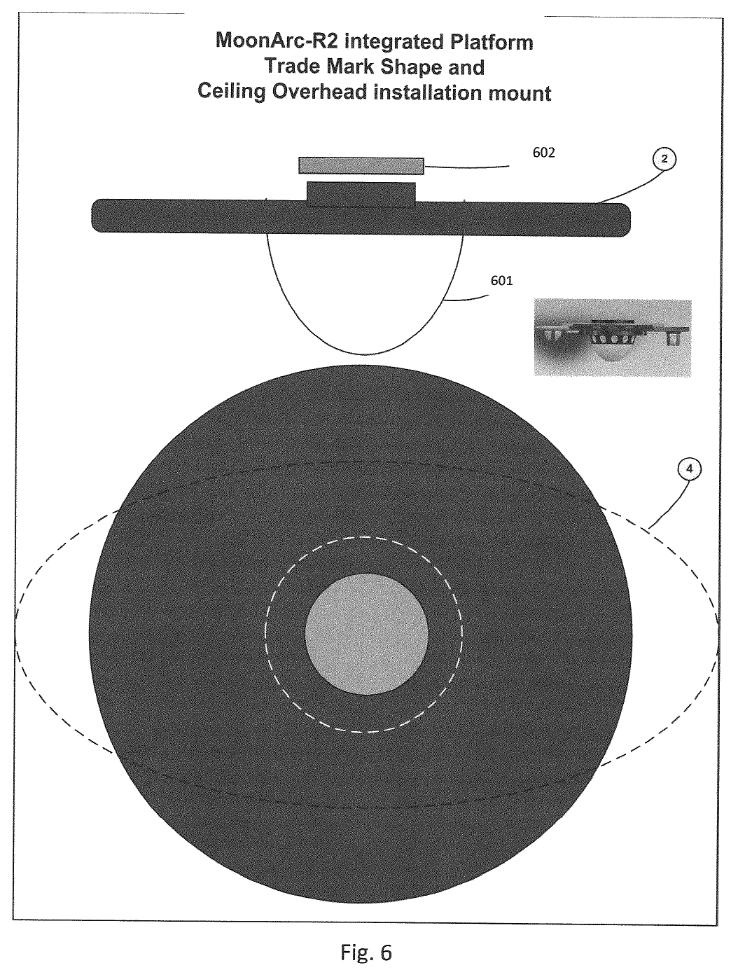

FIG. 6 illustrates an implementation of the integrated output device 107a with a ceiling overhead mounting, according to some embodiments of the present invention. The platform may be a circle or may have an oval shape. The center part may be a transparent dome 601. A ceiling overhead mounting 602 may be used to mount the integrated output device.

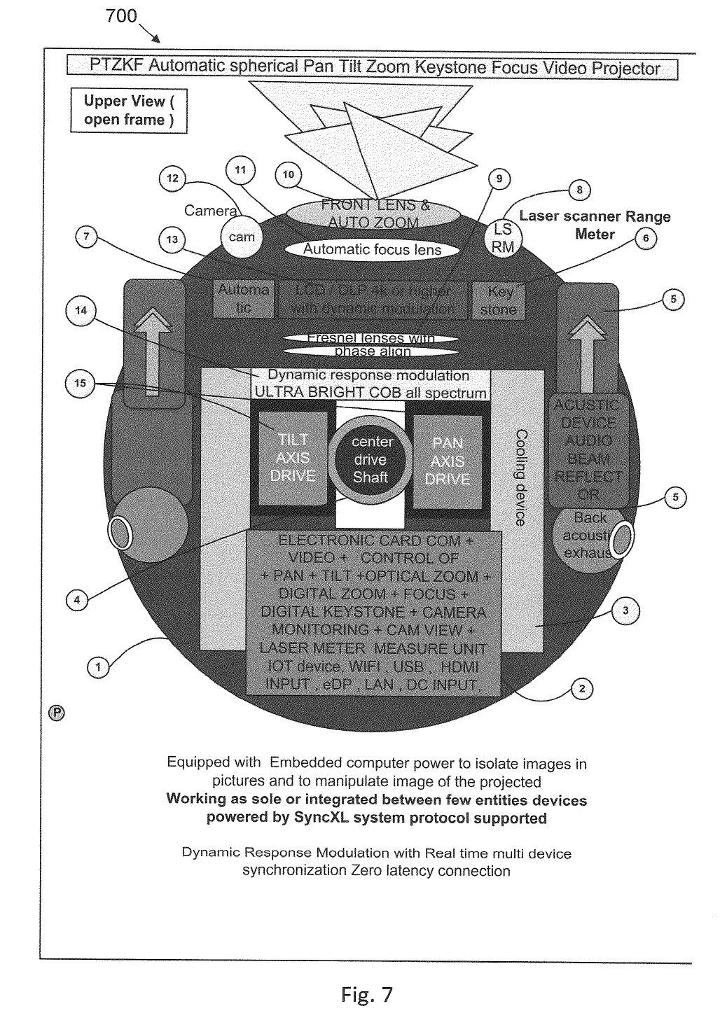

FIG. 7 illustrates an implementation of a PTZFK video projector, according to some embodiments of the present invention.

In accordance with some embodiments of the present invention, the video projector may have pan, tilt, zoom, focus and keystone functions that allow the projector to move to any pan and tilt position and direction and to any given axial position and velocity. This allows the PTZFK video projector to perform an auto zoom onto the video projection, perform an auto focus adjusting to the projected video, perform an auto keystone adjusting to the projected video, as a manual control or automatic or command control. In accordance with some embodiments of the present invention, the PTZKF Projector may include a pan (azimuth) axis motor gear drive and onboard controllable position and velocity control feedback, so as to output the movement to a given position.

In accordance with some embodiments of the present invention, the PTZFK video projector may comprise a tilt (elevation) axis driving motor gear, on board controllable position velocity control feedback circuit, a front CAMERA and an LRSM (Laser Range Scanner Meter) to produce a feedback of the projected video picture, in order to keep the correlations between zoom, focus and keystone at all time of the projected angle in the spherical space. This keeps the picture symmetrical and undistorted and quality of the projected is maintained as HQ definition for the viewer from any given angle.

In accordance with some embodiments of the present invention, the PTZFK video projector may also comprise an audio sound speaker based on wave beams to be reflect back from the projected surface, to provide correlations feel of the audio direction reflected back from projected image to the viewer. Projected light for projecting the image may be at the entire spectrum of visible and non-visible light frequency such as IR band. An embedded computer on board the PTZKF electronic card isolates required images in pictures and is used to manipulate the image to be projected.

In accordance with some embodiments of the present invention, a single motor drive with position and velocity feedback may be utilized to enable controlling a stack of 3 or more PTZKF units with various pan and tilt movements

In accordance with some embodiments of the present invention, cross feed may be used to cancel objects generated by the dynamic response modulation of the high brightness LED COB and LCD control, synchronized between several projectors with zero latency connection and aligned cross line position in the projected space.

In accordance with some embodiments of the present invention, the system may be able to manipulate the projected images, so as to produce an optical illusion on the projected video and images in the projected volume and peripheral projected space. Optical illusions on the projected image and/or correlated projector device may be generated by Fresnel lenses (a type of composite compact lens with large aperture and short focal length) with phase alignment.

In accordance with some embodiments of the present invention, multiple directions scanning may provide the best position to fit the projection of the projection areas and fit it as it should adapt to be projected as a peripheral part of projection of center volume of projected entity in midair volume. Scanning may be performed by a sensor device which scans the room in certain frequency of light and builds a dynamic room map which may be stored in memory, in order to track movements of objects and fit to all scenarios of living.

In accordance with some embodiments of the present invention, the system may monitor the times of the environment flow and may complete the overall experience of the viewer in the space room living room or the space in which the live event should be projected.

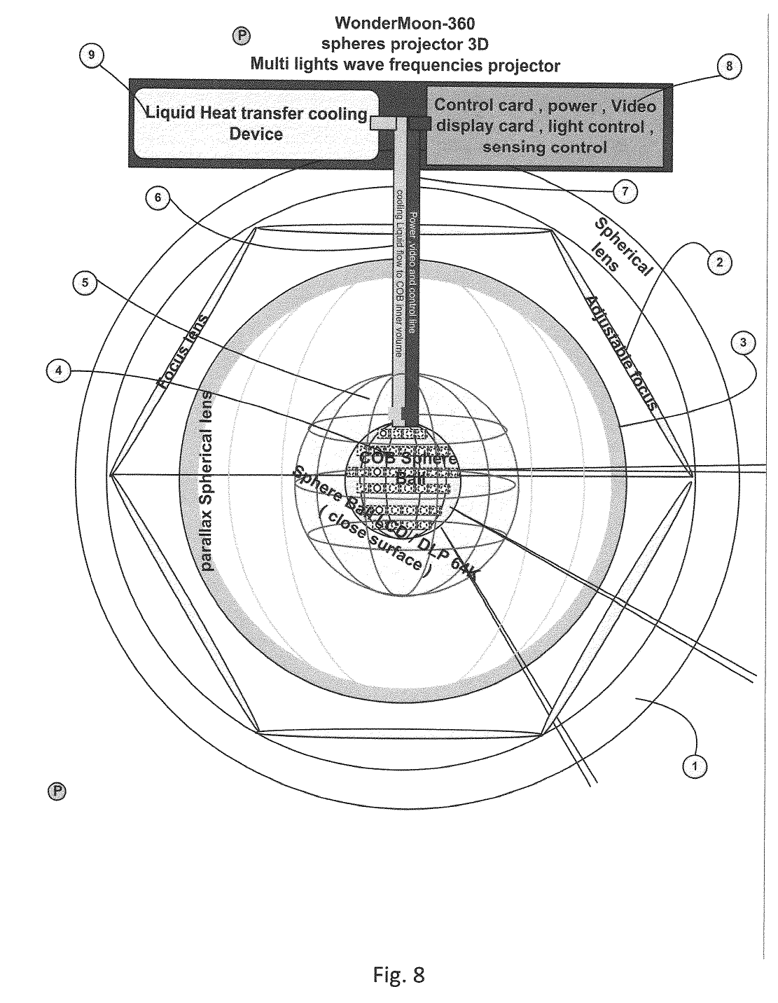

FIG. 8 illustrates an implementation of a Wondermoon 360° projector, according to some embodiments of the present invention. This enables projecting a real complete sphere video to cover all the room space or a different geometric space from single source point of projection. The projector 800 may comprise an outer Spherical lens 801; an adjustable focus lens 802, a Parallax spherical lens 803, an ultra-bright Chip-On-Board (COB-a with all lights spectrum option) 804, a sphere shape LCD/DLP ball 805, cooling liquid device flow to COB inner volume control line 806, power video and control line 807, a control card, power supply, a video display card, a light control circuit, a sensing control circuit 808, a liquid heat transfer cooling device 809, and/or other such diffuser and a like.

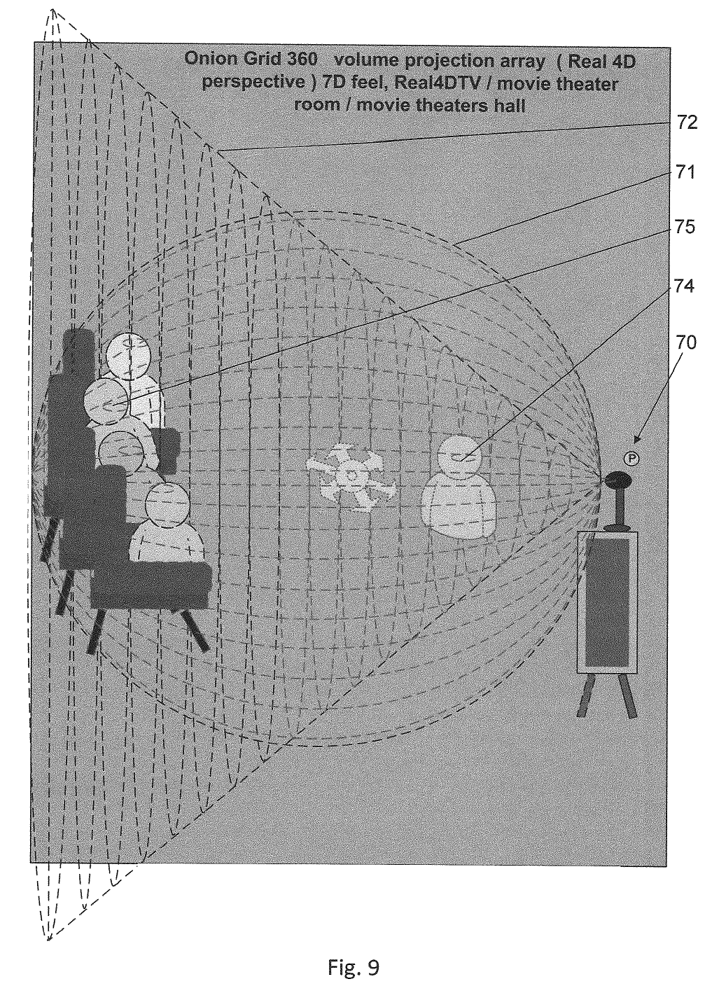

FIG. 9 illustrates an implementation of a 7D projector, according to some embodiments of the present invention.

In accordance with some embodiments of the present invention, the 7D projector 70 may project real 7D 3-D spatial environment in midair space to create a real emulation effect of participating in the live or recorded event. This allows the observer to observe all existing projective environment as he would have been there, in realty. A point of observation may be created as a complete sphere volume using a spherical grid that surrounds the observer 74.

Alternatively, 7D projection may be in the form of a conical shape tunnel 72 that is emitted in the field of view direction as a facing a head tunnel. The 7D projection may also be an overhead emitted sphere or cone or any other geometrical shape to cover the projected area in order to encapsulate the viewers 74 and 75 in the surrounding 7D environment. The projection generates a real volume 7D sphere image/environment that appears in midair, without requiring any display devices.

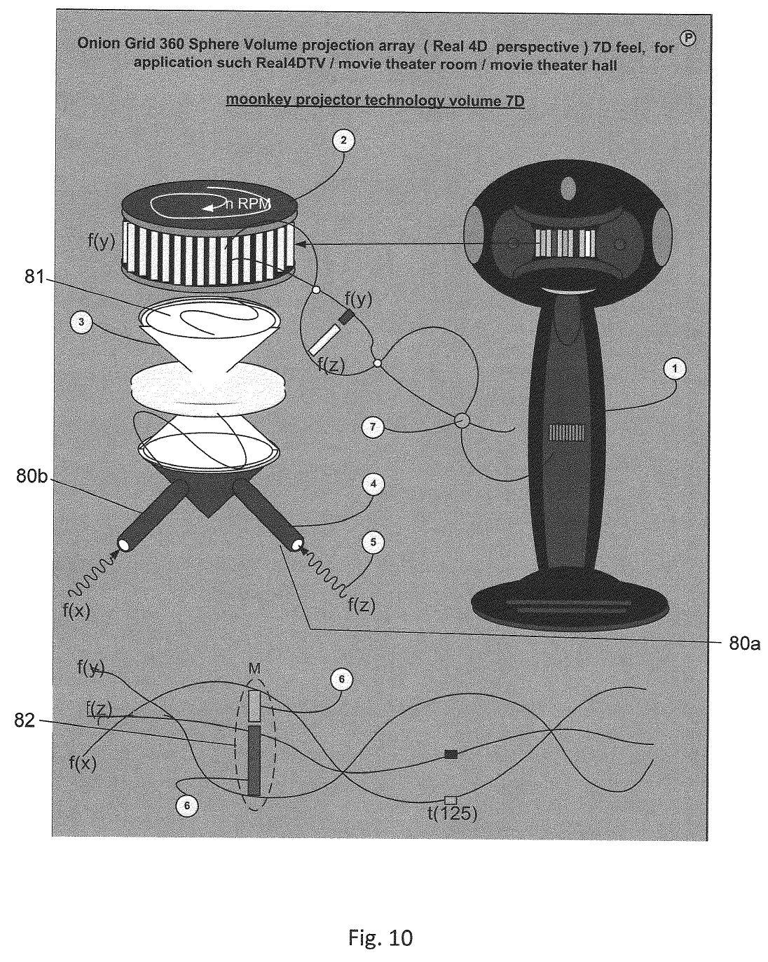

FIG. 10 illustrates the generation of the projected images by the 7D projector, according to some embodiments of the present invention. The projected volume surrounding intact view is generated using transmitted energy, such as optical waves/particles/acceleration of mass energy/frequency that are transmitted alone, or in combination, from the 7D projector 70 using modulated circular wave from two or more orthogonally positioned screw shapes tubes 80a-80b, connected to a prism such as optical prism 81 which generates an output of complete spherical grid in high resolution spherical volume or other geometrical shapes. A disk such as prism 82 with 360° may be spinning at a predetermined rate that produce a related energy, such as optical waves/particles/acceleration of mass energy/frequency that are transmitted alone, or in combination, transmitted into to the grid frequencies waves. The transmitted such as optical waves cause interference in desired points along the grid, while at each point, generating spatial pixels to glow, appear or spark with colors and intensity, in predetermined frequency, colors, intensity, shape and duration that correspond to the surrounding volume to be projected.

In accordance with some embodiments of the present invention, the collection of all generated pixels creates the desired 3D environmental volume view with a perception of real space. The generated spatial grid is completely filled with the spatial pixels (even with the air gaps) that generate the 3D spatial view. The generated pixel may be a modulated cross effect of energy mass of a particle that can be, for example, Atom, proton, neutron or a photon that causes a change in frequency energy mass, to be correlated with predefined frequency energy mass in the volume space, for example, at point 82. The expected resolution may be about 1GQP (volume Pixel) and can be less or higher. The expected data rate may be about 10GQP/s and can be less or higher.

7D projection may also have at least one of emitted power, video and controls card, power supply, circuit, a sensing control circuit, embedded computer on board. In accordance with some embodiments of the present invention, an advanced algorithm may be used to control the synchronization of data beam (Y) in time and specific mass energy to match the spherical beam modulated frequency and mass energy on the overlaying spherical high density volume grid, in order to build the 7D grid volume display perspective and a complete 4D grid volume display.

In accordance with some embodiments of the present invention, similar techniques may be used to generate not only an optical effect in the form of a projected volume surrounding intact view, but also other physical effects such as audio, touch, smell, feel effects using all available bio-senses with any given particles or frequency behavior. In accordance with some embodiments of the present invention, the projector 70 (or several projectors) may project from different angles to simulate a multi-layer of display, for keeping the display volume intact, or to display a multi-dimensional perspective of an event. The resulting view corresponds to emulated generated video or live volume dynamic environment.

In accordance with some embodiments of the present invention, the 7D projection capability may also be used to implement a real 4D television (4DTV), 4D games, 4D theater hall/room that shows movies, 4D meetings, education lessons, remote therapy, and remote medical treatment (such as surgery). Also, such implementations may include any alphabetic characters in any language or symbols that can be shown or pronounced. In addition, the projected view may be generated using AI algorithms to model the spatial environment.

Applicative implementation of the system of the present invention may include broadcasting and production for this kind of perspective media.

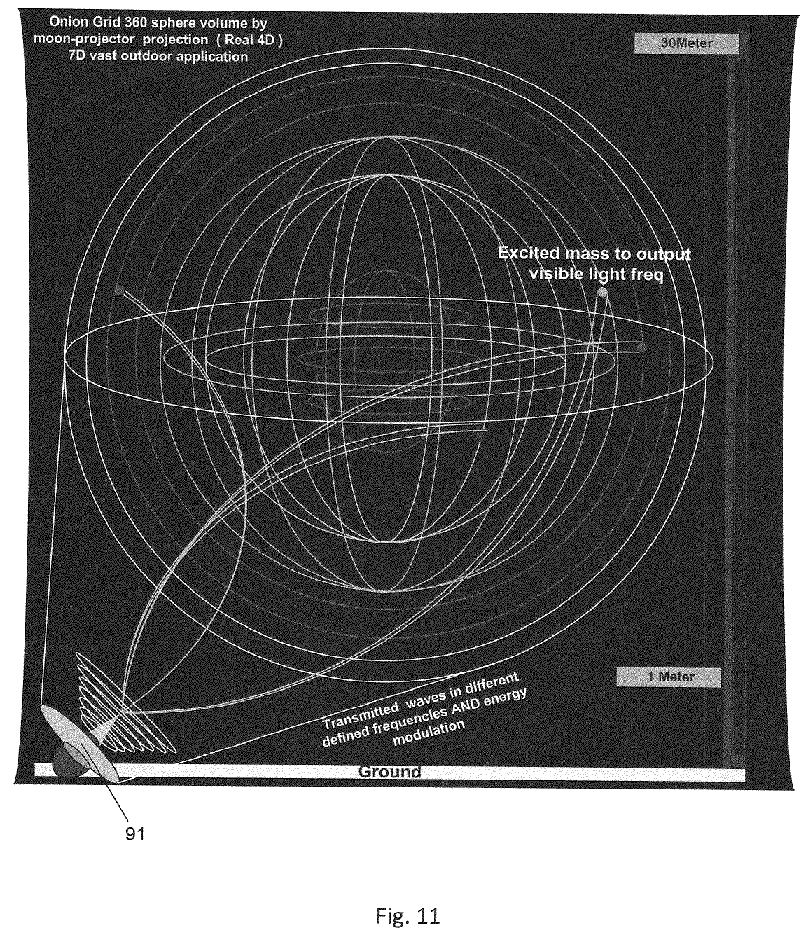

FIG. 11 illustrates an implementation of a large scale outdoor 7D projector, according to some embodiments of the present invention. In this implementation, a gun of particles may be used to transmit energy mass waves and/or particles for example, Atom, proton, neutron and/or a photon, as well as a predefined energy mass in predetermined frequencies and using several transmitted modulation schemes (e.g., by a dish antenna). The desired cross interface may generate a measured reaction between waves and/or particles critical energy mass in order to generate 4D spatial pixels (red, green, blue in this example) at any desired point along the generated spatial 4D grid. The collection of generated pixels then may create the desired view in the volume surrounding. The expected resolution may be about 10GQP volume Pixel and can be less or higher. The expected data rate may be about 100GQP/s, and can be less or higher. 7D projector may have at least one of emitted power, video and controls card, power supply, circuit, a sensing control circuit, embedded computer on board.

7D projection may also have at least one of an eight electrode bulb generated particles energy fields at specific frequency, an acceleration rings array correlating to frequency, empower fields solenoid magnets, and a defined geometric alloy totem hovering line of acceleration to enrich defined particles and stabilizing the medium energy field.

In accordance with some embodiments of the present invention, the audio-visual-sensory and processing device of the system of the present invention may use a combination of means, related to software and hardware, including digital and analog combined logic. Data may be processed in all spectrum frequencies and bands, while harnessing all particle types involving various technologies from the field of physics, chemistry, nano-tech, bio-tech, consciousness, artificial intelligence (AI), consensus and machine artificial consciousness, time and space-based networks, coherent continuous movement, inputs and outputs.

The above examples and description may be implementing as a wide connection networks of endless various events and endless various users all combined to single or parallel mesh networks.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

1. A system for emulating a remote live event or a recorded event at a client side, while optimally preserving the original experience of the live or recorded event, comprising:
a) a remote side being located at the live event 3D spatial environment and being adapted to collect and analyze multi-channels data from an array of sensors deployed at said remote side, said remote side comprises:
b) a publisher device for:
b.1) collecting data from all sensors' multi-channels at said live event;
decoding the channels data to an editable format;
b.2) generating dynamic spatial location and time map layers describing dynamic movements during said live or recorded event;
synchronizing said live event using time, 3D geometric location and media content;
b.3) editing the data of the live event to comply with the displayed scenario and to optimally fit the user's personal space geometric structure;
b.4) generating an output stream that is ready for distribution with adaptation to each client;
c) a client side located at the facility of a user, said client side comprises:
c.1) a multimedia output device for generating for each client, multi-channel signals for executing an emulated local 3-D space with Personal/Public Space Enhancement (PSE) that mimics said live event with high accuracy and adaptation to said facility;
c.2) at least one server for processing live streamed wideband data received from said remote side and distributing edited content to each client at said client side.

2. A system according to claim 1, wherein the audio-visual sensory projection and processing device is adapted to:
a) decode the edited output streams received from the publisher device into multiple data layers running at the client side;
b) synchronize the data and control commands;
c) process the visual and audio signals, lighting signals and signals from sensors;
d) rebuild the scenarios belonging to the live event and make them ready for execution;
e) rout the outputs to each designated device to perform a required task; and
f) distribute outputs that refer to each client. The output can be a visual output in all light frequencies, audio waves in all audio frequencies and sensors reflecting sense.

3. A system according to claim 1, wherein the emulated volume local space is executed by a multimedia output device, which receives the signals generated by an audio-visual-sensors, emulation, projection and processing device for a specific client and executes said signals to generate the emulated local space and PSE for said specific client.

4. A system according to claim 1, wherein the multimedia output device comprises:
a) a video device;
b) a visual device;
c) an audio device;
d) a light fixture device;
e) one or more sensors;
f) power and communication components;
g) smoke generators;
h) fog generators;
i) robotic arms,
j) hovering devices;
k) Machine code devices;
l) Internet of Things (IoT) devices.

5. A system according to claim 1, wherein the light fixture device is a 2-D or 3-D projector having at least pan, tilt, zoom, focus and keystone functions.

6. A system according to claim 5, wherein the light fixture device is a PTZKF projector.

7. A system according to claim 5, wherein the 3-D projector is a sphere projector that projects a real complete sphere video and visual output to cover a geometric space from a single source point of projection.

8. A system according to claim 6, wherein the projector is a 7-D projector.

9. A system according to claim 1, wherein the publisher device uses mathematical and physical values of a dynamic grid along with media channels telemetric data indicators and media content visual and audio.

10. A system according to claim 1, wherein the array of sensors is a sensor ball, which is an integrated standalone unit and is adapted to record, analyze and process an event in all aspects of video, visual, audio and sensory data.

11. The system according to claim 1, wherein data processing at the client and remote sides is done using software and hardware being digital and/or analog processing.

12. The system according to claim 1, wherein artificial Intelligence and machine learning algorithms are used for making optimal adaptations to each client side and remote side.

13. The system according to claim 1, wherein data in the remote and/or client sides is generated and delivered using communication protocols being to utilize high bandwidth for advanced functionality.

14. The system according to claim 1, being adapted to perform at least the following operations:
process, merge and multiplex the data;
synchronize the data between publishers, servers and a plurality of client sides;
perform live streaming of multimedia data on broad high bandwidth networks;
to make adaption to lower bandwidth.

15. The system according to claim 1, wherein an event is selected from the group of:
live or recorded events;
virtual generated events;
played-back events from a local or network source.

16. A system according to claim 2, wherein the audio-visual projection and processing device further comprises a plurality of sensors for exploring the 3D spatial environment of each local user and making optimal adaptation of the editing to said 3D spatial environmental volume.

17. The system according to claim 1, in which the multimedia output device is used as a publisher, to thereby create an event of a local user to be emulated at the 3D space of other users or at the remote event.

18. The system according to claim 1, in which the multimedia output device comprises:
a) an optical source for generating modulated circular waves at predetermined frequencies;
b) two or more orthogonally positioned screw shapes tubes, for conveying said modulated circular waves to a conical prism;
c) a conical prism for generating an output of complete spatial grid with high resolution geometrical shape; and
d) a disk prism spinning at a predetermined rate, for producing transmitted optical waves that cause interference in desired points along said grid, while at each point, generating spatial pixels with colors and intensity that correspond to the image to be projected.

19. The system according to claim 17, in which spatial grid is spherical or conical or any predefined geometric shape.

20. The system according to claim 1, in which the output stream is in a container format, being dedicated for multi-channels.

21. The system according to claim 1, in which the audio-visual sensory projection and processing device is configured to:
a) sample the user local audio output at the user's local side;
b) and performing real-time adaptive synchronization, based on the data extracted from said local audio output, to optimally match the user's local side to the streamed source data.

22. The system according to claim 1, being adapted to perform audio to video synchronization, audio to machine code/light synchronization and video to machine code/light synchronization.

23. The system according to claim 8, wherein the 7D projector is implemented using a gun of particles that transmits energy waves and/or particles, as well as a predefined wave energy mass in predetermined frequencies using several transmitted modulation schemes, to generate a measured reaction between waves critical energy mass, used to generate 4D spatial pixels at any desired point along the generated spatial 4D grid, thereby creating a desired view in the surrounding volume.
